(19) United States
(12) Patent Application Publication
(10) Pub. No.: US 2010/0254241 A1
(43) Pub. Date: Oct. 7, 2010

(54) Hierarchical storage system, library apparatus, magazine, and control method of the hierarchical storage system

(75) Inventor: Kenji Aoki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/801,511

(22) Filed: Jun. 11, 2010

Related U.S. Application Data
(63) Continuation of application No. PCT/JP2007/074147, filed on Dec. 14, 2007.

(51) Int. Cl. G11B 9/00

(52) U.S. Cl. 369/84; 369/291.1; G9B/9

(57) ABSTRACT

A hierarchical storage system has a disc drive, a library apparatus, and a control apparatus. The library apparatus houses a magazine that houses a cartridge. The cartridge has a first tag and stores a storage medium configured to store the data. The magazine has a second tag. The library apparatus acquires through radio communications first information held by the first tag and configured to identify the cartridge and second information held by the second tag and configured to identify the magazine. The library apparatus transmits to the control apparatus the acquired first and second information. The control apparatus memorizes the first and second information, and manages a location of the data based on a data transfer status between the disc drive and the library apparatus and the first information and the second information stored in the first memory.

This application is a continuation of a PCT International Application No. PCT/JP2007/074147, filed Dec. 14, 2007, which is hereby incorporated by reference herein in its entirety.

### BACKGROUND OF THE INVENTION

1. Field of the Invention

The present invention relates to a hierarchical storage system, a library apparatus, a magazine, and a control method of the hierarchical storage system. The present invention is suitable, for example, for a management of data to be stored in a tape cartridge in an archive storage system.

2. Description of the Related Art

The archive storage system is a system configured to store all data for a long term and to make required data viewable, unlike a backup system that is configured to overwrite data. The archive storage system includes a server as a management terminal, a disc drive configured to store data, and a tape library. The tape library houses a plurality of tape cartridges. Data of a high viewing frequency is stored in the disc drive and data of a low viewing frequency is moved from the disc drive to the tape cartridge in the tape library. Thus, the archive storage system is a hierarchical storage system because the data is stored primarily in the disc drive and secondarily in the tape cartridge. The conventional tape cartridge is provided with a barcode indicative of its identifier, and the identifier of the tape cartridge and stored data are managed by one-to-one correspondence.

The conventional archive storage system has no need to store the tape cartridge outside of the archive storage system. However, due to the requirements under the Sarbanes-Oxley Act (“SOX”), it becomes necessary to store all data for a long term. In addition, since there are wide-ranging types of data to be managed, such as documents, still images, and motion images, the information content is also increasing. Hence, the tape cartridge that becomes full in the tape library needs to be preserved in a warehouse outside of the tape library, and it is necessary to supplement an empty tape cartridge to the tape library.

Prior art include Japanese Patent Laid-Open Nos. 2002-154618, 2005-352671, 2006-190241, 2006-23847, 2006-040450 (corresponding to U.S. Pat. No. 7,106,538), 2006-277882 (corresponding to U.S. Pat. No. 7,466,511), 2006-160516 (corresponding to U.S. Patent Application Publication No. 2006/099382), and 2007-174739 (corresponding to U.S. Patent Application Publication No. 2007/139812).

An operator from a management room in which the tape library is arranged cannot track down the tape cartridge, once the tape cartridge is carried in the warehouse outside of the tape library. If the barcode information of the tape cartridge is managed before the tape cartridge is carried in the warehouse, the tape cartridge carried in the warehouse and the data stored in that tape cartridge could be identified. Nevertheless, it is still impossible to identify a location of this tape cartridge in the warehouse. When there are massive tape cartridges in the warehouse, it becomes difficult for an operator of the control room to locate the tape cartridge having required data. As a consequence, it becomes difficult to return the tape cartridge to the tape library, and to restore the required data in the disc drive.

### SUMMARY OF THE INVENTION

The present invention provides a hierarchical storage system that can manage data well, a library apparatus, a magazine, and a control method of the hierarchical storage system.

A hierarchical storage system according to one aspect of the present invention includes a disc drive configured to primarily store data, a library apparatus connected to the disc drive and configured to secondarily store the data, and a control apparatus configured to control a transfer of the data between the disc drive and the library apparatus. The library apparatus includes a port into which a magazine configured to house a cartridge is inserted and from which the magazine is ejected, the cartridge including a first tag and being configured to store a storage medium configured to store the data, and the magazine including a second tag, an information acquisition unit configured to acquire through a radio communication first information held by the first tag and configured to identify the cartridge and second information held by the second tag and configured to identify the magazine, and a first transmitter configured to transmit to the control apparatus the first information and the second information that have been acquired. The control apparatus includes a first memory configured to store the first information and the second information transmitted from the library apparatus, and a management unit configured to manage a location of the data based on a data transfer state between the disc drive and the library apparatus and the first information and the second information stored in the first memory. According to this hierarchical storage system, the library apparatus acquires the first information and the second information through the radio communication, enabling locations of the magazine and the cartridge to be tracked down even when they are carried out of the library apparatus to the outside of the library apparatus.

The magazine may include a reader configured to read the first information, and a second transmitter configured to transmit the first information and the second information to the library apparatus. Since the second transmitter can transmit both the first information and the second information, the number of transmitters becomes smaller than the number of transmitters that transmit the first information and the second information separately and independently.

The second tag may be an active tag, the magazine may further include a writer configured to write the first information in the second tag, and the second transmitter may be a part of the second tag. Since the second tag that is made writable can transmit both the first information and the second information, the number of transmitters becomes smaller than the number of transmitters that transmit the first information and the second information separately and independently. The second tag may hold status information of the magazine, such as positional information and battery information. Thereby, the controller can manage the status of the magazine, and track down the cartridge or magazine which stores the required data.

The second transmitter may be configured to transmit the first information and the second information to the library apparatus on a regular basis or when information previously transmitted by the second transmitter has changed. The transmission on a regular basis enables the control apparatus to manage the first information and the second information on a regular basis. The transmissions made when the information previously transmitted by the second transmitter has changed enable the control apparatus to find the abnormality immediately.

The magazine may further include a second memory configured to store the first information and the second information, and the second transmitter may be configured to transmit to the library apparatus the first information and the second information that are stored in the second memory. In this case, it is unnecessary for the second tag to store the first information. In addition, it is unnecessary for the second tag to provide long-distance radio communications. The second memory may store status information of the magazine. Thereby, the controller can manage the status of the magazine, and track down the cartridge or magazine which stores the required data.

There is provided a control method according to another aspect of the present invention of a hierarchical storage system that includes a disc drive configured to primarily store data, a library apparatus connected to the disc drive and configured to secondarily store the data, and a control apparatus configured to control a transfer of the data between the disc drive and the library apparatus The control method includes acquiring, from a magazine configured to house a cartridge through a radio communication via an information acquisition unit of the library apparatus, first information held by a first tag and configured to identify the cartridge and second information held by a second tag and configured to identify the magazine, the cartridge including the first tag and being configured to store a storage medium configured to store the data, the magazine including the second tag, transmitting to the control apparatus via the library apparatus, the first information and the second information that have been acquired, storing, via the control apparatus, the first information and the second information in a memory, which have been sent from the library apparatus, and managing a location of the data via the control apparatus based on a data transfer status between the disc drive and the library apparatus and the first information and the second information stored in the memory. According to this control method of the hierarchical storage system, the information acquisition unit of the library apparatus acquires the first information and the second information through the radio communication, enabling locations of the magazine and the cartridge to be tracked down even when they are carried out of the library apparatus to the outside of the library apparatus.

A library apparatus according to another aspect of the present invention configured to manage a storage medium configured to store data includes a port into which a magazine configured to house a cartridge is inserted and from which the magazine is ejected, the cartridge including a first tag and being configured to store the storage medium, and the magazine including a second tag, an information acquisition unit configured to acquire through a radio communication first information held by the first tag and configured to identify the cartridge and second information held by the second tag and configured to identify the magazine, and a management unit configured to manage a location of the data based on a data storing status into the storage medium and the first information and the second information. According to this library apparatus, the information acquisition unit acquires the first information and the second information through the radio communication, enabling locations of the magazine and the cartridge to be tracked down even when they are carried out of the library apparatus to the outside of the library apparatus. The information acquisition unit may radio-communicate with the radio communication unit of the magazine or the second tag, such as an active tag.

A magazine according to another aspect of the present invention is configured to house a cartridge. The cartridge is configured to store a storage medium that is configured to store data. The magazine includes a reader configured to read first information, the first information being configured to identify the cartridge and held by a first tag that is provided to the cartridge, a second tag configured to hold second information configured to identify the magazine, and a transmitter configured to transmit the first information. Since this magazine has the transmitter, the location of the data can be tracked down through radio communications. For example, the magazine may include a slot configured to house the cartridge, and the reader may be formed on the surface of the slot. Thereby, the radio communication is available once each cartridge is inserted into the slot.

A hierarchical storage system according to another aspect of the present invention includes a disc drive configured to primarily store data, a library apparatus connected to the disc drive and configured to secondarily store the data, a magazine configured to house a cartridge being configured to be inserted into and ejected from the library apparatus, the cartridge including a first tag configured to hold first information and being configured to store a storage medium configured to store the data, and the magazine including a first radio communication unit and a second tag configured to hold second information, the first information being configured to identify the cartridge, and the second information being configured to identify the magazine, a control apparatus configured to control a transfer of the data between the disc drive and the library apparatus, and a second radio communication unit configured to communicate with the first radio communication unit. The control apparatus may detect a position of the cartridge based on the first information and the second information which the second radio communication unit has received from the first radio communication unit. According to this hierarchical storage system, the control apparatus can detect the location of the cartridge that houses the required data by utilizing the radio communications.

There may be a plurality of magazines each configured to house a plurality of cartridges. The second radio communication unit may acquire from the first radio communication unit arrangement information of the magazines in a warehouse configured to store the magazines. The arrangement information may contain positional information of each magazine, an identifier of each magazine, and an identifier of each cartridge housed in each magazine. Thereby, the control apparatus can locate the cartridge that stores specific data in the warehouse. The control apparatus may further include a memory configured to store a map of the warehouse, and the control apparatus may be configured to identify positions of the cartridges in the warehouse by superimposing the arrangement information of the magazines on the map of the warehouse. Thereby, the control apparatus can locate the cartridge that stores specific data in the warehouse more easily and more effectively.

The magazine may further include a display unit, and the control apparatus may transmit a display command to be displayed on the display unit of the magazine, to the first radio communication unit via the second radio communication unit. Thereby, an operator can locate a magazine that houses a target cartridge in the warehouse more easily and more effectively.

The magazine may further include a battery. The first radio communication unit may be configured to transmit information on a short remaining battery life of the magazine to the second radio communication unit. The control apparatus may further include a memory configured to store a map of the warehouse, and may be configured to identify a position of the magazine having the short remaining battery life in the warehouse by superimposing the arrangement information of the magazines on the map of the warehouse. Thereby, the control apparatus can locate the magazine having a short remaining battery life in the warehouse more easily and more effectively. The magazine may further include a display unit. The control apparatus may be configured to transmit a display command to be displayed on the display unit of the magazine, to the first radio communication unit via the second radio communication unit. Thereby, an operator can locate a target magazine in the warehouse more easily and more effectively.

Further features of the present invention will become apparent from the following description of exemplary embodiments with reference to the attached drawings.

### BRIEF DESCRIPTION OF THE DRAWINGS

FIG. 1 is a system structural diagram of an archive storage system (hierarchical storage system) according to a first embodiment.

FIG. 2 is an illustrative data management table stored in a management apparatus (control apparatus) in the archive storage system shown in FIG. 1.

FIG. 3 is a perspective view of a tape library (library apparatus) of the archive storage system shown in FIG. 1.

FIG. 4 is a perspective view showing that a front cover opens in the tape library shown in FIG. 3.

FIG. 5 is a perspective view showing that an inner cover opens in the tape library shown in FIG. 4.

FIG. 6 is a perspective view showing that the magazine is loaded after the inner cover of the tape library shown in FIG. 4 is opened.

FIG. 7 is a partially enlarged sectional view of the tape library shown in FIG. 5.

FIG. 8 is a partially enlarged perspective view of FIG. 7.

FIG. 9 is a perspective view of the tape cartridge in the archive storage system shown in FIG. 1.

FIG. 10 is a perspective view of the magazine of the archive storage system shown in FIG. 1.

FIG. 11 is a perspective view of the magazine shown in FIG. 10 which is viewed with a different angle.

FIG. 12 is a block diagram showing a control system of the magazine shown in FIG. 10.

FIG. 13 is a flowchart for explaining an operation of the archive storage system shown in FIG. 1.

FIG. 14A is a flowchart for explaining details of the step 1200 shown in FIG. 13. FIG. 14B is a flowchart for explaining details of the step 1250 shown in FIG. 14A. FIG. 14C is a flowchart for explaining details of the step 1270 shown in FIG. 14A. FIG. 14D is a flowchart for explaining an operation of a control system after the step 1277 shown in FIG. 14C.

FIG. 15 is a flowchart for explaining another operation (maintenance process) of the archive storage system shown in FIG. 1.

FIG. 16 is a flowchart for explaining a method for identifying a magazine having a short remaining battery life in the warehouse in the step 1750 shown in FIG. 15.

FIG. 17 is a block diagram of a control system according to a second embodiment which corresponds to the control system shown in FIG. 12.

FIG. 18 is a block diagram of a control system according to a third embodiment which corresponds to the control system shown in FIG. 12.

FIG. 19 is a block diagram of a control system according to a fourth embodiment which corresponds to the control system shown in FIG. 12.

FIG. 20 is a block diagram of a control system according to a fifth embodiment which corresponds to the control system shown in FIG. 12.

FIG. 21 is a perspective view of a tape cartridge according to the embodiment shown in FIG. 20.

### DESCRIPTION OF THE EMBODIMENTS

Referring now to the accompanying drawings, a description will be given of an archive storage system that serves as a hierarchical storage system according to one embodiment of the present invention.

### First Embodiment

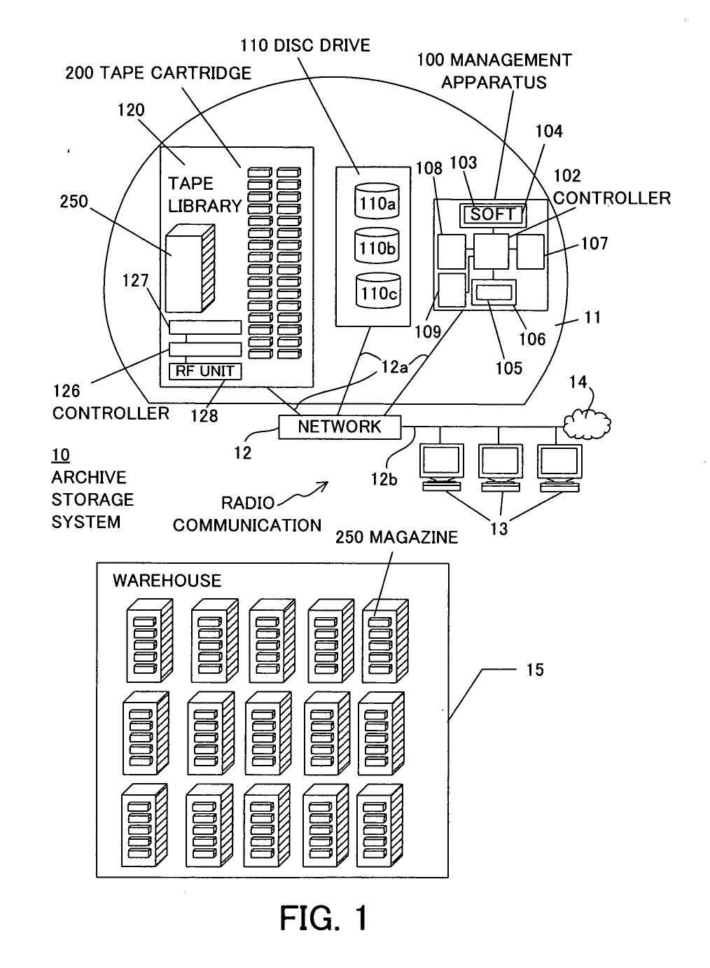

FIG. 1 is a system structural diagram of the archive storage system (hierarchical storage system) 10 according to a first embodiment. The archive storage system 10 is partially arranged in a management room 11, and includes a network 12 and a variety of terminals 13, and a plurality of magazines 250 stored in a warehouse 15 play one role of the archive storage system 10.

The management room 11, a room in which a variety of terminals 13 are placed, and the warehouse 15 may be located on the same floor or on the different floors. However, the warehouse 15 is distant from the management room 11 by a radio-communicatable distance, such as several meters to about 10 m. A type of the network 12 is not limited, and can include a local area network (“LAN”), a wide area network (“WAN”), or a fibre channel (“FC”). The network 12 is connected to the variety of terminals 13 and the Internet 14 via cables 12b. The variety of terminals 13 includes a computer, a server, and a storage device.

The management room 11 houses the management apparatus (control apparatus) 100, one or more disc (or disk) drives 110, and the tape library (library apparatus) 120, and these components are connected to one another through cables 12a and via a hub, and a switch etc. Of course, they may be directly connected without intervening the hub or the switch. The tape library 120 houses a plurality of tape cartridges 200 and a pair of magazines 250 in this embodiment, for example.

According to the archive storage system 10, all data are initially stored in one of the disc drives 110, and data of a high viewing frequency is maintained in the disc drive 110. Data of a low viewing frequency is moved from the disc drive 110 to the tape cartridge 200 in the tape library 120, and deleted from the disc drive 110. In the tape library 120, the tape cartridge 200 that stores data that is seldom viewed is moved to the magazine 250. The magazine 250 can house a plurality of tape cartridges 200, and moved to the warehouse 15 outside of the tape library 120 when the magazine 250 houses a predetermined number (or maximum number) of tape cartridges 200. The warehouse 15 is located on the same floor as the management room 11 in this embodiment. The warehouse 15 stores a plurality of magazines 250.

The management apparatus 100 includes a server or a personal computer (“PC”), and manages each component in the archive storage system 10. The management apparatus 100 includes a controller 102, such as a CPU or an MPU, and a memory 104 configured to store management software (“SOFT”) 103 and related information, a memory 106 configured to store a data management table 105, an input unit 107, a display unit 108, and an output unit 109. The management apparatus 100 controls a transfer of the data between the disc drive 110 and the tape library 120.

The controller 102 controls each component in the archive storage system 10 in accordance with the SOFT 103. The controller 102 serves as a management unit configured to manage a location of the data based on the data transfer status between the disc drive 110 and the tape library 120, and information stored in the memory 106.

The SOFT 103 provides a variety of processes including: (1) primarily storing data in the disc drive 110 from each of the variety of terminals 13, and adding the stored data to the data management table 105; (2) processing a viewing request; (3) determining a viewing frequency; (4) secondarily storing the data from the disc drive 110 to the tape cartridge 200, and updating the data management table 105 with the stored data; (5) moving the tape cartridge 200 into the magazine 250 in the tape library 120; (6) informing an operator that the magazine 250 is ready to move to the outside; and (7) informing an operator of a location of the tape cartridge 200 in the warehouse 15. The memory 104 includes a ROM, a RAM, and/or a variety of types of storage devices.

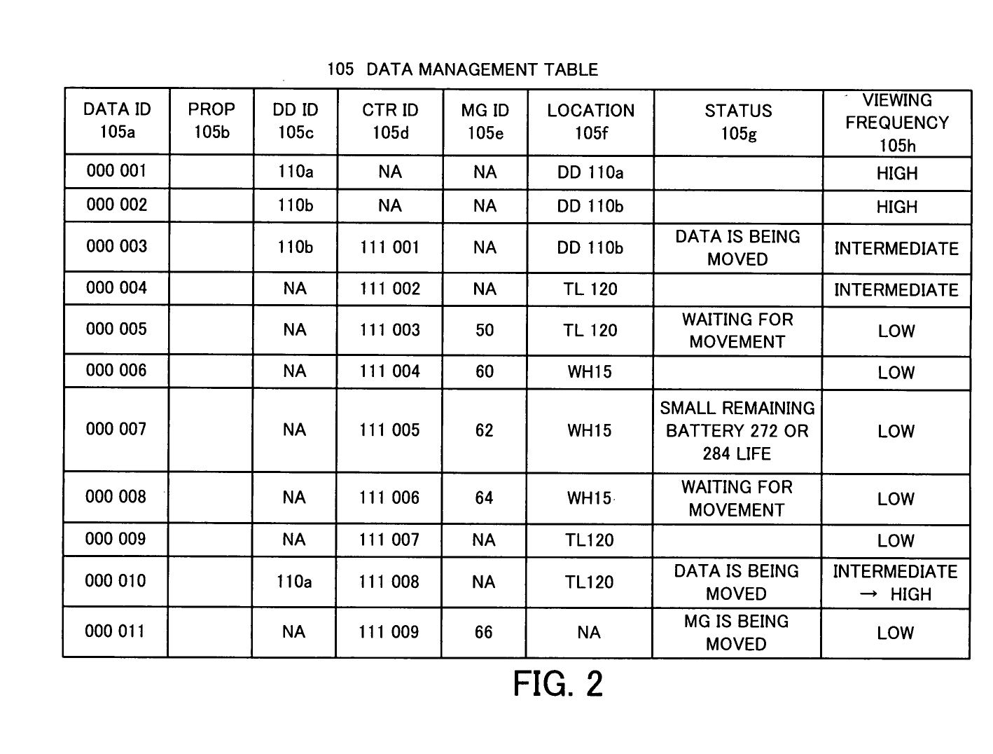

FIG. 2 is one illustrative data management table 105. The data management table 105 is generated by the controller 102 whenever the information is stored in the disc drive 110 from the terminal 13. The data management table 105 contains a variety of fields: These fields include, but are not limited to, data ID (identification) 105a, property (“PROP”) 105b, disc drive (“DD”) ID 105c, tape cartridge (“CTR”) ID 105d, magazine (“MG”) ID 105e, location 105f, status 105g, and viewing frequency 105h.

The data ID field 105a is a unique identifier which the controller 102 provides to stored data. In FIG. 2, a serial number is assigned starting from 000001 but a method of generating a unique identifier is not limited.

The property field 105b contains a type of data, such as a document, a still image, a motion image, another format or an extension that indicates the format, a program used for the data, a size of data, a variety of date and time, such as a preparation date and time, an updating date and time, and an access date and time, the corresponding terminal 13 and the room and/or department of that terminal 13, user information of that terminal 13, etc. The property field 105b usually includes the location field 105f but the location field 105f is separated for description purposes in this embodiment.

The disc drive ID field 105c is a unique identifier that identifies the disc drive 110 configured to store the data. In this embodiment, as shown in FIG. 1, the disc drive ID field 105c identifies one of a plurality of disc drives 110 (110a to 110c). Data 000001 and 000010 are stored in the disc drive 110a, and data 000002 and 000003 are stored in the disc drive 110b. In FIG. 2, “NA” means that there is no corresponding disc drive 110. For example, none of the disc drives 110 store data 000004.

The tape cartridge ID field 105d is a unique identifier that identifies the tape cartridge 200 configured to store data. In this embodiment, the unique identifier is previously produced by a manufacturer. As a result, the tape cartridge 200 and the tape cartridge ID can be managed by one-to-one correspondence. In this embodiment, as shown in FIG. 1, the tape cartridge ID field 105d identifies one of a plurality of tape cartridges 200. Data 000003 to 000010 are stored in the tape cartridges 111001 to 111008. In FIG. 2, “NA” means that there is no corresponding tape cartridge 110. For example, none of the tape cartridges 200 store the data 000001.

The magazine ID field 105e is a unique identifier used to identify the magazine 250 configured to store the tape cartridge 200. In this embodiment, the unique identifier is previously produced by a manufacturer. As a result, the magazine 250 and the magazine ID can be managed by one-to-one correspondence. In this embodiment, as shown in FIG. 1, the magazine ID field 105e identifies one of a plurality of magazines 250. Cartridges 111003 to 111006 are stored in the magazines 50, 60, 62, and 64. In FIG. 2, “NA” means that there is no corresponding magazine 250. For example, the tape cartridge 111002 is stored in a cell 140, which will be described later 120 in the tape library 120, and stored in none of the magazines 250.

An identifier (first information) of the tape cartridge 200 and an identifier (second information) of the magazine 250 are sent from the tape library 120, and the memory 106 stores this information in the data management table 105.

The location field 105 indicates a current location (room) in which data is deposited. In FIG. 2, the data 000001 is stored in the disc drive 110a, the data 000002 and 000003 are stored in the disc drive 110b. The data 000004, 000005, 000009, and 000010 are located in the tape library (“TL”) 120, and the data 000006 to 000008 are located in the warehouse (“WH”) 15. In FIG. 2, “NA” means that there is no corresponding room 250. For example, since data 000011 are being carried between the management room 11 and the warehouse 15, and none of the room has the data 000011.

The status field 105g indicates a status of the data or tape cartridge 200 or the magazine 200. In FIG. 2, a blank means a normal state. When it is not a normal state, its reason is filled out.

For example, the data is stored either in the disc drive 110 or in the tape cartridge 200, and is not simultaneously stored in both units. Nevertheless, the data 000003 is corresponded to the disc drive ID and the tape cartridge ID. This is because the data 000003 is moved from the disc drive 110b to the tape cartridge 111001 as described in the status field 105g. After the movement ends, the controller 102 deletes the disc drive ID from the data 000003 and changes the location field 105f to the TL 120. Thereafter, the controller 102 will blank out the corresponding status field 105g.

For the same reason, the data 000010 is provided with the disc drive ID and the tape cartridge ID. This is because the data 000010 is moved from the tape cartridge 111008 to the disc drive 110b as described in the status field 105g. After the movement ends, the controller 102 deletes the tape cartridge ID from the data 000010, and changes the location field 105f to DD 110a. Thereafter, the controller 102 will blank out the corresponding status field 105g.

After the tape cartridge 200 that has moved to the magazine 250, that tape cartridge 200 will be finally moved with that magazine 250 to the warehouse 15 and removed from the tape library 120. For the data 000005, since the tape cartridge 200 is provided with the magazine ID and thus moved to the magazine 250, the location field 105f indicates the tape library 120. This is because as described in the status field 105g, the magazine 50 is waiting for movement from the tape library 120 to the warehouse 15. The mark “waiting for movement” is labeled when a transporter is not ready or the magazine 250 stores only a small amount of tape cartridges 200. After the transportation ends, the controller 102 changes the location field 105f of the data 000005 to WH 15, and blanks out the corresponding status file 105g.

The status field 105g also informs the operator that the magazine 62 that houses the tape cartridge 111005 that stores the data 000007 has a small remaining battery life. Thereby, the operator will exchange the battery of the magazine 62. Thereafter, the controller 102 will blank out the corresponding status field 105g.

The status field 105g also informs the operator that the magazine 64 that houses the tape cartridge 111006 that stores the data 000008 is waiting for movement. Thereby, the operator will move the magazine 64 from the warehouse 15 to the tape library 120. Thereafter, the controller 102 will change the location field 105f to TL 120, and blank out the corresponding status field 105g.

The status field 105g informs the operator that the magazine 66 that houses the tape cartridge 111009 that stores the data 000011 is being moved between the management room 11 and the warehouse 15. After the movement ends, the controller 102 changes the location field 105f to TL 120 or WH 15, and blanks out the corresponding status field 105g.

The status field 105g may also identify whether the tape cartridge 200 is located in the cell 140 or in the tape unit 160.

The viewing frequency field 105h indicates a viewing frequency of data stored in the disc drive 110 or the tape cartridge 200.

The memory 106 includes a ROM, a RAM, and/or a variety of storage devices. The input unit 107 includes a keyboard, a ten-key, and a variety of pointing devices, such as a mouse and a trackball. The display unit 108 displays the data management table 105, data to be managed, and other management related data. The output unit 109 includes a printer and a speaker that emits an alarm sound.

The disc drives 110 constitute redundant arrays of inexpensive disks (“RAID”) in this embodiment, but a storage type is not limited. In this embodiment, there are a plurality of disc drives 110 (110a to 110c), each primarily storing data to be managed. The present invention does not prevent the disc drive 110 from storing the data management table 105. The disc drive 110 configured to primarily store the data and the tape library 120 configured to secondarily store the data constitute a hierarchical storage system.

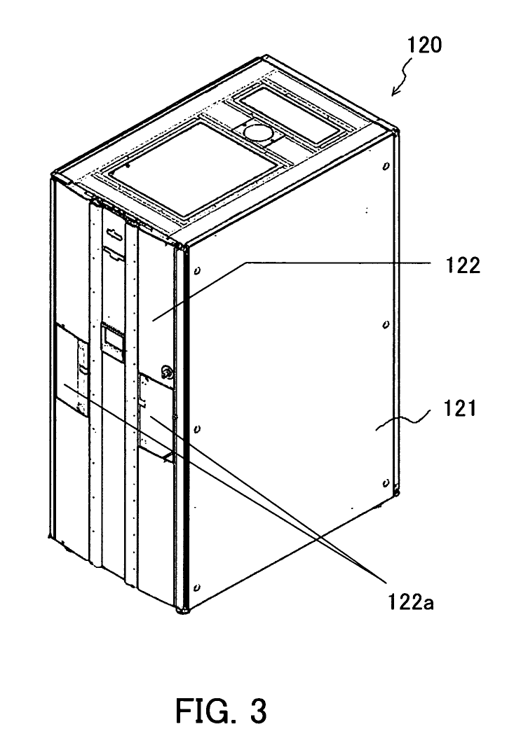

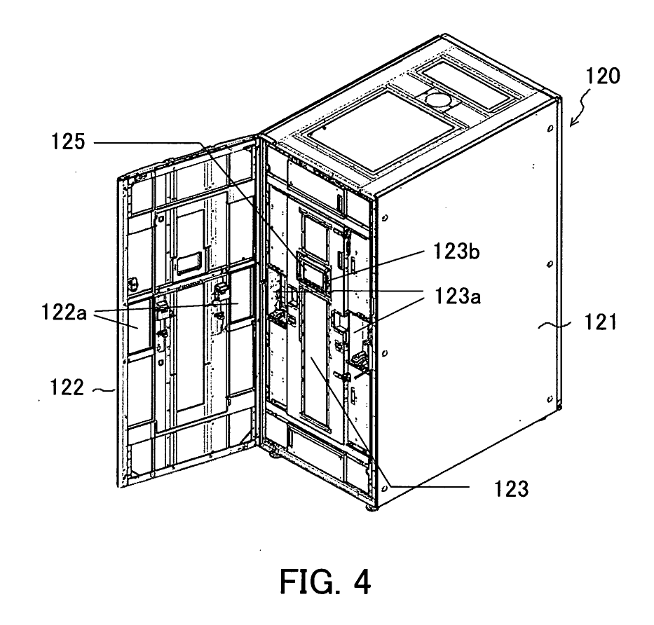

FIG. 3 is a perspective view of the tape library 120. FIG. 4 is a perspective view showing that a front cover 122 opens in the tape library 120 shown in FIG. 3. The tape library 120 is connected to the disc drive 110 via the cable 12a, secondarily stores the data, and houses a plurality of tape cartridges 200 and a pair of magazines 250 in the housing 121.

The housing 121 has a rectangular parallelepiped shape (box shape), and the front cover 122 is attached to its front surface via a hinge (not shown) so that the front cover 122 can open and close. When the front cover 122 is opened, as shown in FIG. 4, an inner cover 123 is attached via a hinge (not shown) so that the inner cover 123 can open and close. The front cover 122 is provided with a pair of openings 122a, and the inner cover 123 is provided with a pair of openings 123a and one opening 123b. The openings 122a and 123a correspond to each other, and are connected to each of a pair of cartridge access stations (“CAS”) 130. The opening 123b exposes a console 125.

The console 125 is used to enter a variety of commands for a variety of unlocks, to instruct a robot 150 to move the tape cartridge 200 to the cell 140 when a new magazine 250 that stores a plurality of empty tape cartridges 200 is loaded.

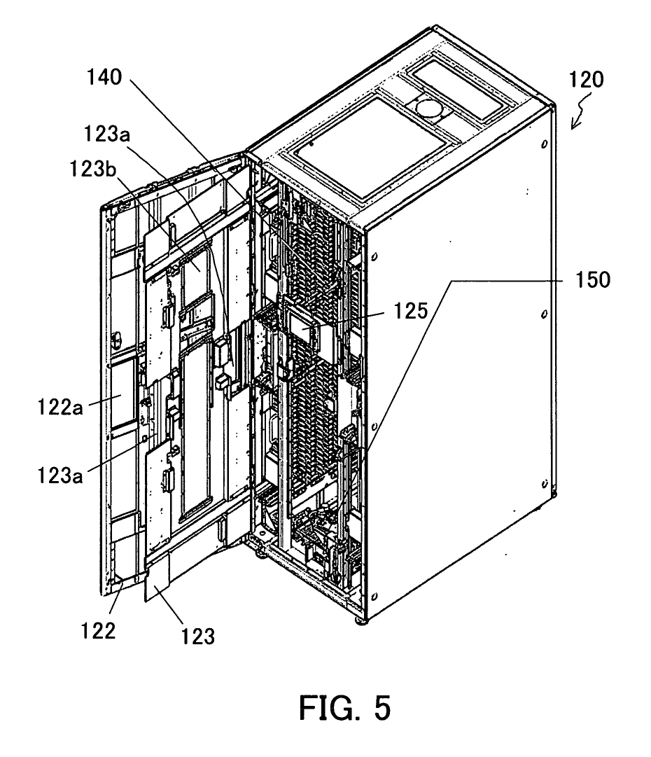

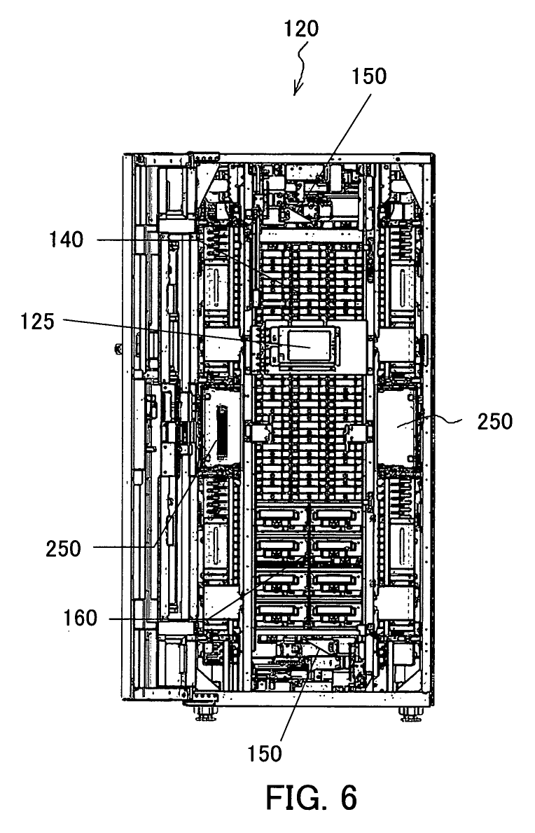

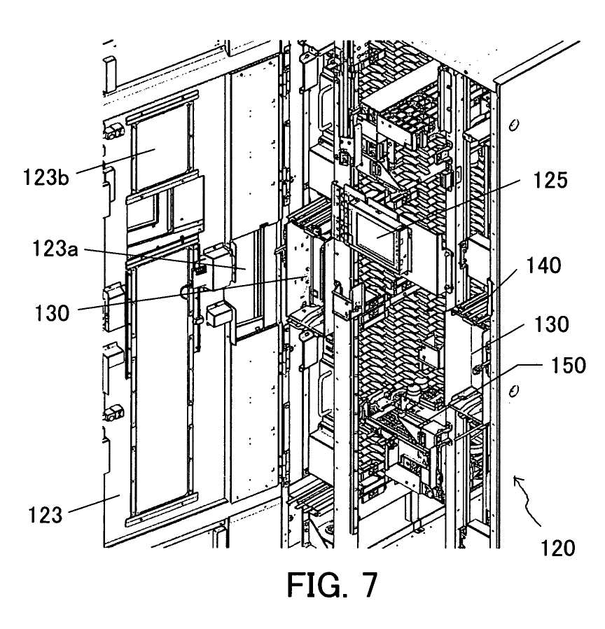

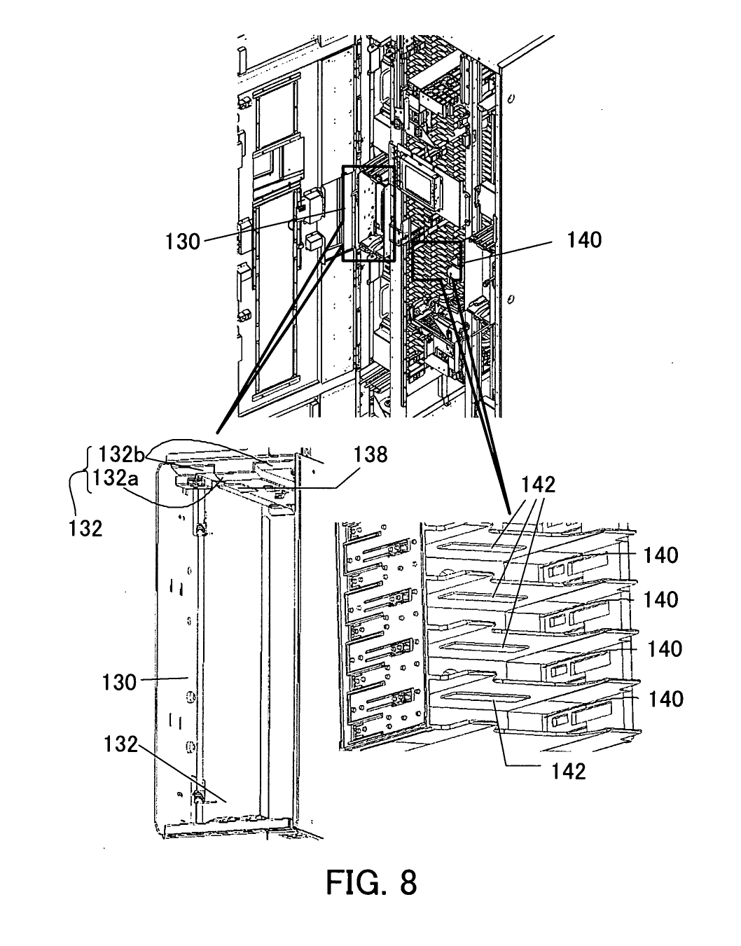

FIG. 5 is a perspective view showing that the front cover 122 and the inner cover 123 open in the tape library 120. FIG. 6 is a front view showing a loading state of the magazine 250 after the front cover 122 and the inner cover 123 of the tape library 120 are opened. FIG. 7 is a partially enlarged perspective view of FIG. 5. FIG. 8 is a partially enlarged perspective view of FIG. 7.

The tape library 120 includes a controller 126, a communication unit 127, a radio communication (“RF”) unit 128, a pair of CASs 130, a plurality of cells 140, a pair of robots 150, and a tape unit 160.

The controller 126 includes a CPU or an MPU, and is configured to control each component of the tape library 120 based on software stored in a memory (not shown), information input from the console 125, and an instruction from the controller 102. In another embodiment, the controller 126 serves as a management unit configured to manage a location of data based on a data storing status into the tape cartridge 200, an identifier of the tape cartridge 200, and an identifier of the magazine 250. This embodiment is, for example, an embodiment in which the tape library 120 is directly connected to a host, and the controller 126 serves as the controller 102.

The communication unit 127 can communicate with the management apparatus 100, and send the acquired identifier of the tape cartridge 200 and the acquired identifier of the magazine 250 to the management apparatus 100.

The radio communication unit 128 serves as an information acquisition unit configured to communicate with the magazine 250 through a radio communication and to acquire the identifier of the tape cartridge 200 (first information) held by a passive tag (first tag) 220 and the identifier of the magazine 250 (second information) held by an active tag (second tag) 280. The radio communication unit 128 serves as a reader/writer configured to read data from the active tag 280, and to write data in the active tag 280. In this embodiment, the radio communication unit 128 is integrated with the tape library 120, but may be integrated with the management room 11 or formed as an independent unit connected to the network 12.

The CAS 130 is an inlet/outlet port into which the magazine 250 is inserted and from which the magazine 250 is ejected. As shown in the left bottom in FIG. 8, the CAS 130 has upper and lower rail members 132. The rail member 132 has a convex 132a and a pair of concaves 132b. The CAS 130 also includes a tag reader 138 configured to read information in the active tag 280 provided to the magazine 250. Another embodiment replaces the tag reader 138 with a reader/writer that can write information. Although the operator manually inserts the magazine 250 into the CAS 130 and ejects the magazine 250 from the CAS 130 in this embodiment, an external feeder performs this function in another embodiment.

The cell 140 is a housing unit into which the tape cartridge 200 is inserted and from which the tape cartridge 200 is ejected. As shown in the right bottom in FIG. 8, the cell 140 has a tag reader 142 configured to read information of a wireless IC tag provided to the tape cartridge 200.

In this embodiment, the tag reader 138 reads information from the active tag 280 in a non-contact manner, and the tag reader 142 reads information from the passive tag 220 in a non-contact manner. However, the present invention does not preclude use of a contact type of an IC tag and tag reader.

The robot 150 transports the tape cartridge 200 among the magazine 250, the cell 140, and the tape unit 160 in the CAS 130.

The tape cartridge 200 is inserted into and ejected from the tape unit 160. The tape unit 160 records data in the tape cartridge 200, and reproduces data from the tape cartridge 200.

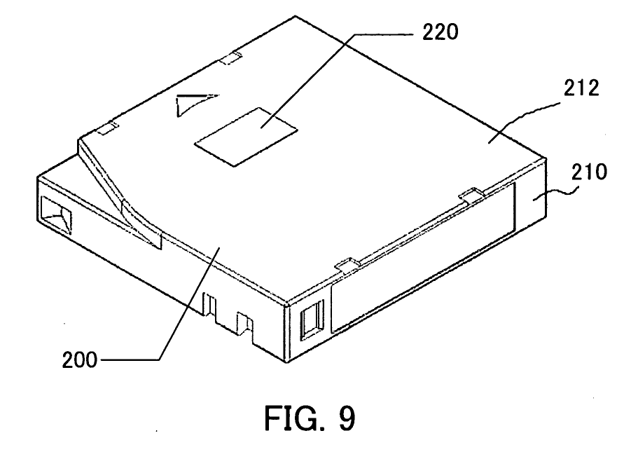

FIG. 9 is a perspective view of the tape cartridge 200. The tape cartridge 200 has a passive tag (first tag) 220 on a top surface 212 of a case 210. The case 210 houses a tape (storage medium) (not shown) configured to store data. The passive tag 220 is one type of a non power source type wireless IC tag (RFID tag) that does not require a battery. The “wireless IC tag” is a small radio frequency tag IC chip used to identify an object, stores its identifier, and serves to transmit and receive information with a management system through a radio communication. The “wireless IC tag” having a built-in battery is referred to as an “active tag.”

More specifically, the passive tag 220 is supplied with power resulting from the induction power by the reader/writer, and a communication distance ranges from several millimeters to about 1 m. However, it is inexpensive and maintenance-free, and has an almost semi-permanent life. The passive tag 220 includes an IC chip and an antenna, and can be made small. The passive tag 220 can use a band of 135 kHz or smaller, 13.56 MHz, UHF, or 2.45 GHz.

Thus, the tape cartridge 200 of this embodiment uses the passive tag 220, and the passive tag 220 stores the identifier of the tape cartridge 200 (first information). As described above, the identifier of the tape cartridge 200 is data of the cartridge ID field 105d of the data management table 105 shown in FIG. 2. It is conceivable to use an active tag instead of the passive tag 220. However, the active tag needs to be exchanged when its battery runs short, and it is arduous to exchange a battery of the active tag for each of many tape cartridges 200. Therefore, this embodiment uses the passive tag 220 for the tape cartridge for cost reductions and power saving.

When the passive tag 220 is moved from the tape library 120 to the warehouse 15, the management room 11 cannot communicate with the passive tag 220 because a communication range of the passive tag 220 is 1 m or smaller. Accordingly, this embodiment provides the magazine 250 with a means for extending a communication distance of the tape cartridge 200 so that an operator of the management room 11 can locate the tape cartridge 200 in the warehouse 15.

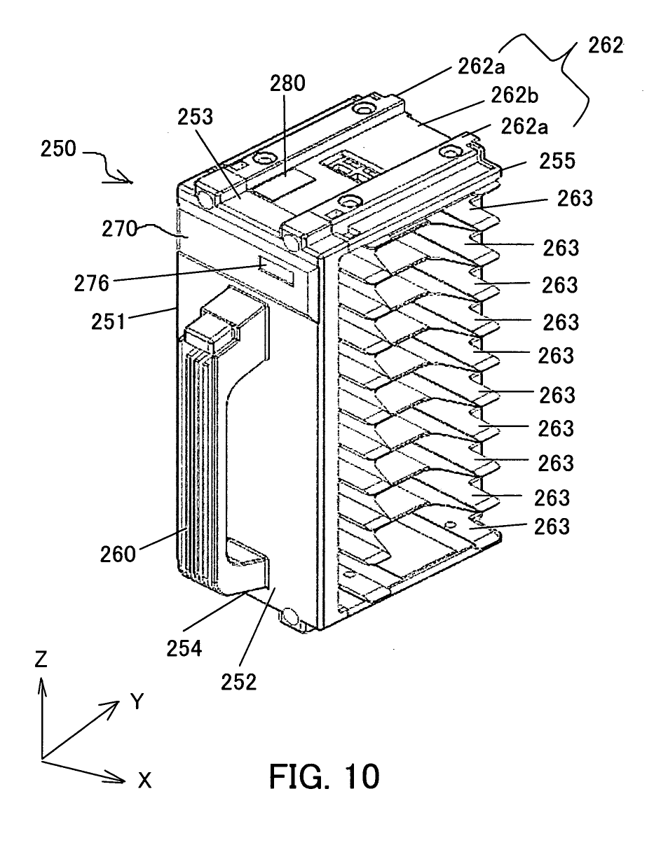

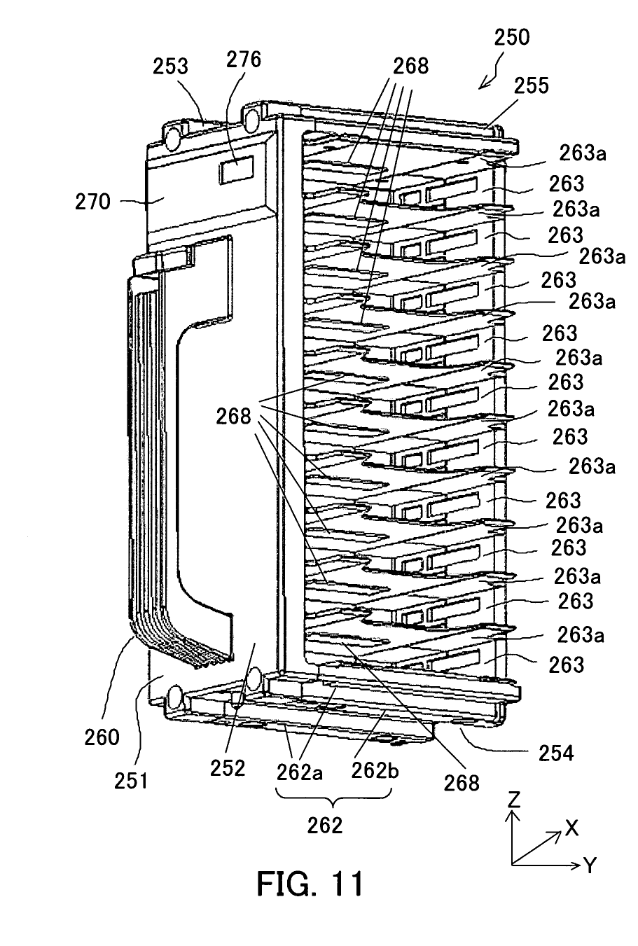

FIGS. 10 and 11 are perspective views of the magazine 250 viewed with different angles. The magazine 250 includes a housing 251, a control unit 270, an active tag (second tag) 280, and a tag reader 268. The housing 251 has an approximately rectangular parallelepiped shape (box shape), and possesses a front surface 252, a top surface 253, a bottom surface 254, and a side surface 255.

A grip 260 is fixed onto the front surface 252. The control unit 270 is provided to the top of the front surface 252, and a display unit 276 of the control unit 270 can be visually inspected from the outside of the tape library 120 via the openings 122a and 123a.

A guide member 262 that includes a pair of convexes 262a and a concave 262b are formed on the top surface 253 and on the bottom surface 254. The active tag 280 is fixed onto the top surface 253, as shown in FIG. 10. The side surface 255 opens, and a plurality of stages of slots 263 are arranged in the Z direction. The tape cartridge 200 can be inserted into and ejected from each slot 263 in the X direction. A tag reader (first reader) 268 is attached to the top surface 263a of each slot 263, as shown in FIG. 11. Each tag reader 268 reads the identifier from the passive tag 220 adhered to the top surface 212 of the tape cartridge 200.

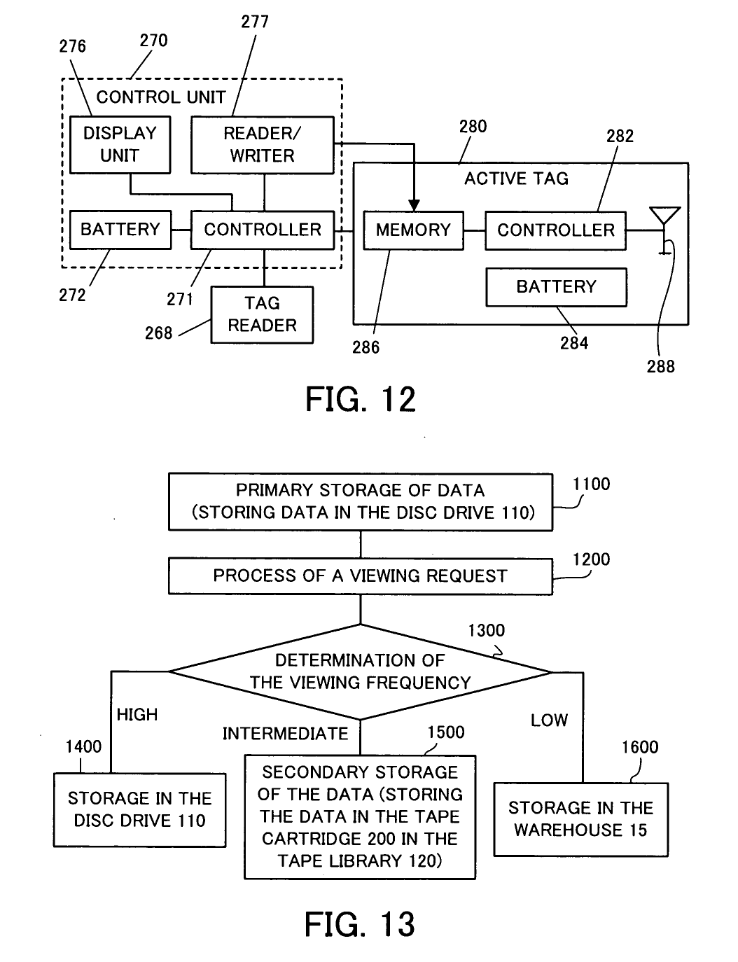

FIG. 12 is a block diagram of the magazine 250. The control unit 270 includes a controller 271, a battery 272, a display unit 276, and a reader/writer 277.

The controller 271 includes a CPU or an MPU, communicates with the controller 126 of the tape library 120 and the controller 102 of the management apparatus 100, and controls an operation of the magazine 250, in particular, operations of the battery 272, display unit 276, the reader/writer 277, and the tag reader 268 shown in FIG. 12.

The battery 272 supplies power to each component of the control unit 270.

The display unit 276 includes a liquid crystal display or a lamp, and indicates a status of the magazine 250. These statuses include, but are not limited to: (1) an attachment of the magazine 250 to the CAS 130 of the tape library 120; (2) a separation of the magazine 250 from the CAS 130; (3) a short battery 284 life of the active tag 280; (4) running out of the battery 284; and (5) informing a user of a position of the magazine 250.

The reader 277 serves to write information read from each tag reader 268 in the active tag 280 and to read the information from the active tag 280. The reader/writer 277 can also write remaining battery 272 life information (or exchange prompting information) into the active tag 280.

The active tag 280 includes a controller 282, a battery 284, a memory 286, and a radio communication unit 288. The active tag 280 is supplied with power from the battery 284, and the communication distance is about 10 m. However, it is expensive and requires an exchange of the battery 284. In addition, the active tag 280 has a two-year to five-year life, and is large because it has a substrate and the battery 284. The active tag 280 can use a band of 303 MHz, 315 MHz, 433 MHz, or 2.45 GHz.

Both of the passive tag 220 and active tag 280 can provide bidirectional communications as well as unidirectional communication. In addition, each tag may be made as a read only (“RO”) type, a write once read many (“WORM”) type, and a read write (“RW”) type. The active tag 280 of this embodiment is a RW type.

The controller 282 controls each component of the active tag 280. The battery 284 supplies power to each component of the active tag 280. The controller 282 can store the remaining battery 284 life information (or exchange prompting information) in the memory 286. The memory 286 stores the identifier of the magazine 250 (second information). As described above, the identifier of the magazine 250 is data of the magazine ID field 105e in the data management table 105 shown in FIG. 2. In addition, the memory 286 also stores data read from the tag reader 268 by the reader/writer 277. Moreover, the memory 286 holds exchange information of the batteries 272 and 284. Moreover, data is written in the memory 286 by the radio communication unit (reader/writer) 128. The radio communication unit 288 radio-communicates with the radio communication unit 128, and informs the radio communication unit 128 of information in the memory 286. The radio communication unit 288 serves as a second transmitter configured to transmit the identifier of the tape cartridge 200 and the identifier of the magazine 250 to the tape library 200. The transmission may be made on a regular basis, such as once a day.

This embodiment uses the active tag 280 of the magazine 250 to transmit the information of the tape cartridge 200 and the magazine 250 to the radio communication unit 128, and it is unnecessary to provide an independent radio communication unit to the magazine 250. In addition, since data stored in the passive tag 220 of the tape cartridge 200 is written in the active tag 280 via the tag reader 268 and the reader writer 277, it is unnecessary to provide to the magazine 250 a memory configured to store the data in the passive tag 220.

Referring now to FIG. 13, a description will be given of the operation of the archive storage system 10. Here, FIG. 13 is a flowchart for explaining an operation of the archive storage system 10.

Initially, the controller 102 primarily stores data from the terminal 13 in the disc drive 110, and produces the data management table 105 (step 1100). A type of the data is not particularly limited, and the controller 102 can execute the step 1100 for each predetermined time period, such as storing at 0:00 a.m. data that has prepared for just previous 24 hours. The data includes a document, a still image, a motion image, an e-mail, and other information, and a unit of the storage may be a department, a people, a type of data, another unit, or a combination thereof. After the data is primarily stored, the controller 102 prepares or updates the data management table 105 in the memory 106. The data management table 105 is, for example, the data 000001 and 000002 shown in FIG. 2. Just after the data is primarily stored, the controller 102 sets the viewing frequency field 105h to “high” even when there is no viewing history.

Next, the controller 102 processes the viewing request (step 1200), and makes the data stored in the disc drive 110 viewable on the terminals 13 via the network 12.

Next, the controller 102 determines the viewing frequency of the data (step 1300). The viewing frequency is determined based on the number of viewing requests divided by a set period, such as two weeks, one month, and three months. The memory 106 also stores a threshold of the viewing frequency. The controller 102 calculates the viewing frequency on a regular basis (for example, every six months or every year), and compares the result with the threshold stored in the memory 106. This embodiment prepares a first threshold and a second threshold smaller than the first threshold as thresholds. When the calculated viewing frequency is equal to or larger than the first threshold, the controller 102 sets “high” to the viewing frequency field 105h. When the calculated viewing frequency is between the first threshold and the second threshold, the controller 102 sets “intermediate” to the viewing frequency field 105h. When the calculated viewing frequency is smaller than the second threshold, the controller 102 sets “low” to the viewing frequency field 105h.

Although FIGS. 2 and 13 classify the data according to the viewing frequency, the present invention is not limited to this embodiment. For example, the data may be classified according to a span of the preservation term of the data. For instance, data that is required by law to preserve for ten years may be stored in the disc drive 110 for the first three years, and stored in the tape library 120 for the next three years, and stored in the warehouse 15 for the last four years. In this case, it is conceivable to dispose data that has passed ten years, and the data management table 105 may have a disposal field. Data may be classified according to a command of the operator of the management apparatus 100.

Next, the controller 102 assigns data of a high viewing frequency to storage in the disc drive 110 (step 1400), data of an intermediate viewing frequency to storage in the tape library 120 (step 1500), and data of a low viewing frequency to storage in the warehouse 15 (step 1600).

In the step 1400, the controller 102 maintains the current state when the data has already been located in the disc drive 110 as in the data 000001 and 000002 shown in FIG. 2. However, when the data is located in the tape library 120 like the data 000010, the controller 102 moves the data to the disc drive 110, and updates the cartridge ID field 105d, the location field 105f, the status field 105g, and the viewing frequency field 105h in the data management table 105.

Similarly, in the step 1500, the controller 102 maintains the current state when the data has already been located in the tape library 120 like the data 000004 shown in FIG. 2. However, when the data is located in the disc drive 110 like the data 000003, the controller 102 moves the data to the tape library 120, and updates the disc drive ID field 105c, the cartridge ID field 105d, the location field 105f, the status field 105g, and the viewing frequency field 105h in the data management table 105.

Moreover, in the step 1600, the controller 102 maintains the current state when the data has already been in the warehouse 15 like the data 000006 shown in FIG. 2. However, when data is located in the tape library 120 like the data 000005, the operator is prompted via the display unit 108 to move the tape cartridge 200 that stores that data to the magazine 250 and to move that magazine 250 to the warehouse 15. When the operator moves the magazine 250 to the warehouse 15, the controller 102 updates the cartridge ID field 105d, the location field 105f, the status field 105g, and the viewing frequency field 105h in the data management table 105. Thereafter, the operator inserts into the CAS 130 a new magazine 250 loaded with empty tape cartridges 200. Next, the controller 102 instructs the controller 126 of the tape library 120 to move the new tape cartridge 200 to the cell 140 via the robot 150. At this time, the controller 126 of the tape library 120 may recognize the IDs of the magazine 250 and the tape cartridge 200 and inform the controller 102, or the controller 102 may acquire that information when storing data in the tape cartridge 200.

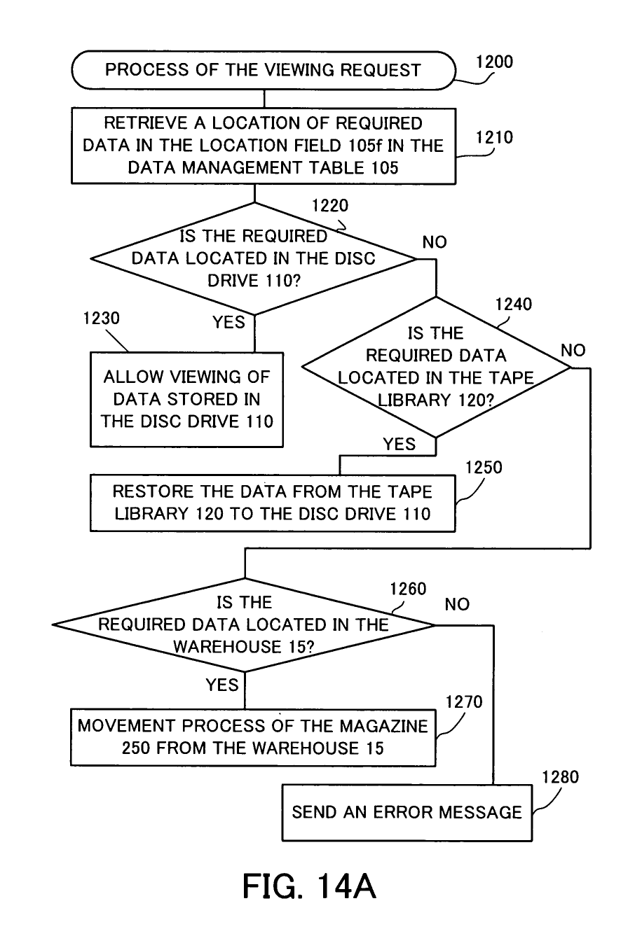

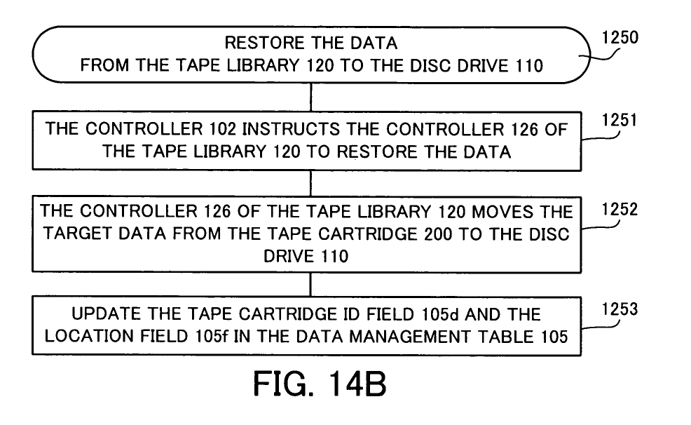

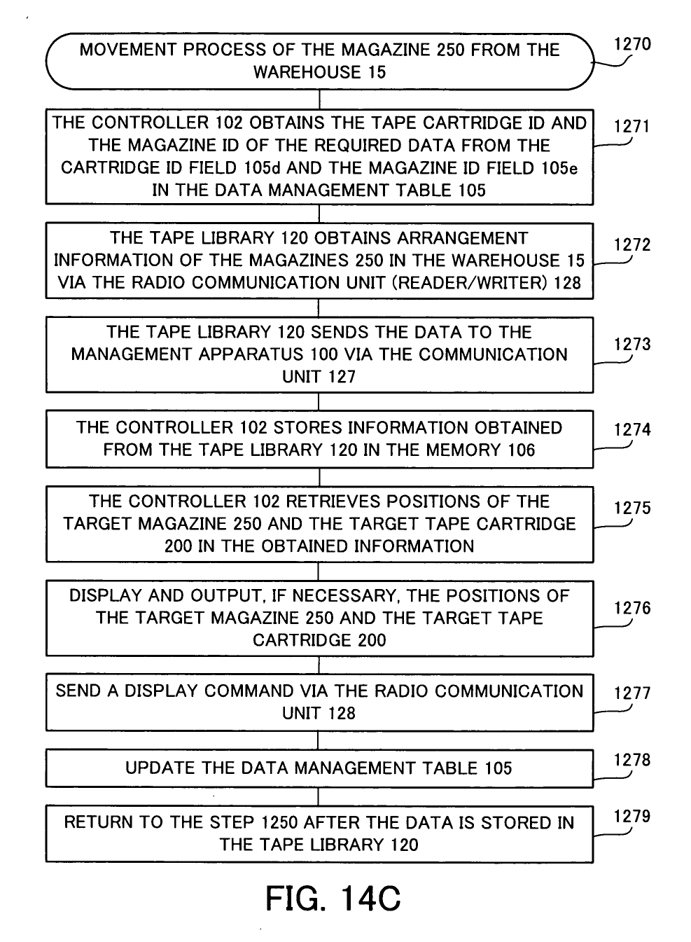

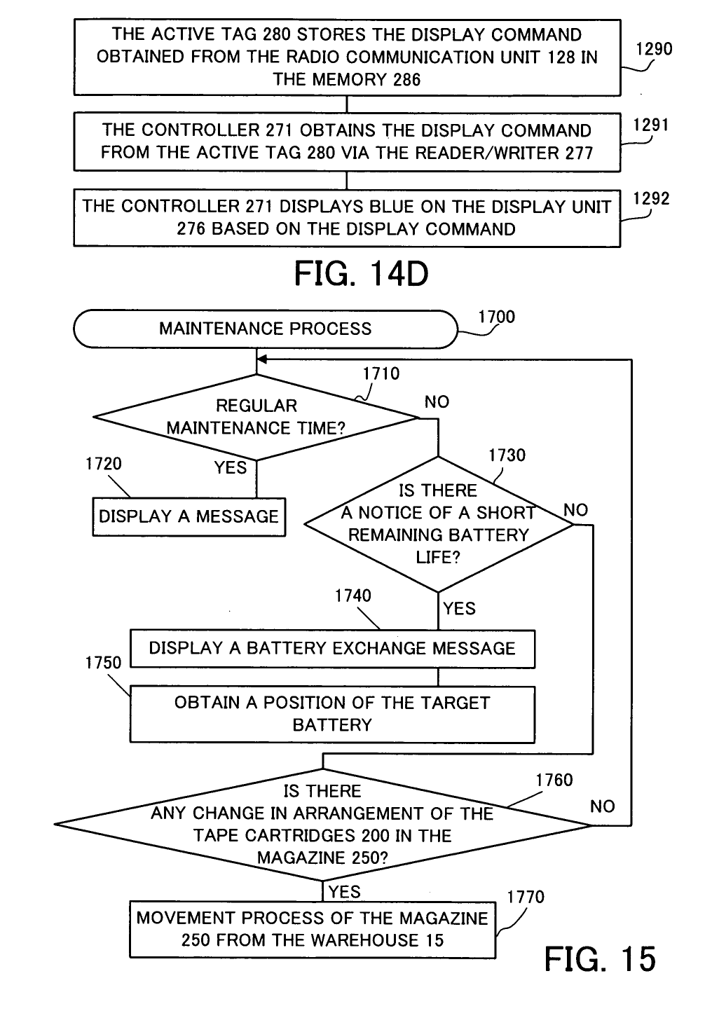

Referring now to FIGS. 14A to 14C, a description will be given of details of the process of the viewing request (step 1200). Here, FIG. 14A is a flowchart for explaining the details of the step 1200.

Initially, the controller 102 retrieves the location of required data in the location field 105f in the data management table 105 (step 1210). When determining that the required data is located in the disc drive 110 (step 1220) as a result of a retrieval of the location field 105f, the controller 102 allows a requester, such as the terminal 13, to view the data in the disc drive 110. When determining that the required data is located in the tape library 120 (steps 1220 and 1240) as a result of the retrieval of the location field 105f, the controller 102 restores the data from the tape library 120 to the disc drive 110 (step 1250).

FIG. 14B is a flowchart of details of the step 1250. Initially, the controller 102 instructs the controller 126 of the tape library 120 to restore the data (step 1251). Next, the controller 126 of the tape library 120 moves the data from the tape cartridge 200 to the disc drive 110 (step 1252). Next, the controller 102 updates the tape cartridge ID field 105d to “NA,” the location field 105f to “DD 110,” and the viewing frequency field 105h to “high” in the data management table 105 (step 1253).

When determining that the required data is located in the warehouse 15 (steps 1220, 1240, and 1260) as a result of the retrieval of the location field 105f, the controller 102 processes a movement of the magazine 250 out of the warehouse 15 (step 1270). In the movement process (step 1270), a data acquisition is time-consuming and thus the controller 102 informs the data requester that the viewing will be available shortly. When determining that the required data is located in none of the disc drive 110, the tape library 120, and the warehouse 15 (steps 1220, 1240, and 1260) as a result of the retrieval of the location field 105f, the controller 102 sends an error message to the requester (step 1280).

Referring now to FIG. 14C, a description will be given of the movement process of the magazine 250 from the warehouse 15 (step 1270). FIG. 14C is a flowchart for explaining the details of the step 1270.

Initially, the controller 102 acquires the tape cartridge ID and the magazine ID of the required data from the cartridge ID field 105d and the magazine ID field 105e in the data management table 105 (step 1271).

On the other hand, the tape library 120 acquires arrangement information of the magazines 250 in the warehouse 15 through the radio communication unit (reader/writer) 128 (step 1272). The tape library 120 sends the arrangement information of the magazines 250 through the communication unit 127 (step 1273). The arrangement information is, for example, similar to the warehouse 15 shown in FIG. 1, and includes the positional information of the magazines 250, an identifier of each magazine 250, and an identifier of each tape cartridge 200 housed in each magazine 250. Next, the controller 102 stores the information obtained from the tape library 120 in the memory 106 (step 1274).

Next, the controller 102 retrieves in the information of acquired in the step 1272 a position of the target magazine 250 having the magazine ID acquired in the step 1271 and a position in the target magazine 250 of the target tape cartridge 200 having the cartridge ID acquired in the step 1271 (step 1275). As a result, it is possible based on the arrangement information to identify where the target magazine 250 is located and where the target tape cartridge 200 is located in which slot 263 in the target magazine 250. At this time, the controller 102 may superimpose the results of the steps 1273 and 1274 on the map of the warehouse 15. The map of the warehouse 15 is stored in the memory 106. By superimposing with the map of the warehouse 15, for example, it is possible to recognize the target magazine 250 is located near the right side of a second pillar that is located at the right side of a door.

Next, the controller 102 displays the positions of the target magazine 250 and the target tape cartridge 200 on the display unit 108 and outputs them, if necessary, to the output unit 109 (on the map of the warehouse 15) (step 1276). Next, the controller 102 sends a display command via the radio communication unit 128 (step 1277). Thereby, an operator can easily find the target magazine 250 in the warehouse 15. Data of the warehouse 15 is, for example, the data 000008 shown in FIG. 2. After the magazine 250 is moved out of the warehouse 15, the controller 102 updates the location field 105f and the status field 105g, like the data 000011 shown in FIG. 2 (step 1278). After the magazine 250 is housed in the tape library 120, the controller 102 instructs the controller 126 of the tape library 120 to move the tape cartridge 200 from the magazine 250 to the cell 140 via the robot 150. Thereafter, the controller 102 returns to the step 1250 (step 1279).

Referring now to FIG. 14D, a description will be given of an operation of the control system shown in FIG. 12 after the display command is sent (step 1277). Here, FIG. 14D is a flowchart for explaining an operation of the control system after the step 1277. Initially, the active tag 280 stores the display command acquired from the radio communication unit 128 in the memory 286 (step 1290). Next, the controller 271 acquires the display command from the active tag 280 via the reader/writer 277 (step 1291). Next, the controller 271 displays blue on the display unit 276 based on the display command (step 1292). Thereby, an operator who enters the warehouse 15 can quickly and easily find the blue lighting magazine 250 as the target magazine 250. The display command may use another color, such as red, another lighting method, such as littering, and another method, such as a generation of an alarm sound.

According to this embodiment, the operator of the management room 11 can recognize not only the fact that the target tape cartridge 200 is located in the warehouse 15 but also its position in the warehouse 15 and its position in the target magazine 250. Therefore, the data management becomes easy.

Referring now to FIG. 15, a description will be given of a maintenance process (step 1700) provided by the controller 102. Initially, the controller 102 determines whether it is a regular maintenance time (step 1710). When determining that it is the regular maintenance time, the controller 102 displays a message on the display unit 108 informing the operator that now is the maintenance time (step 1720). Next, the controller 102 determines whether the controller 102 has received a notice of a short remaining battery life (step 1730). With such a notice (step 1730), the controller 102 indicates a battery exchange message on the display unit 108 (step 1740). In the step 1740, the controller 102 indicates a type of the battery or whether it is the battery 272 of the control unit 270 of the magazine 250 or the battery 284 of the active tag 280. This embodiment highlights the “short remaining battery life” in the status field 105g in the data management table 105.

Next, the controller 102 acquires a position of the target battery to be exchanged (step 1750). When the target battery is the battery 272 of the control unit 270 of the magazine 250 and the magazine 250 is loaded in the tape library 120, the controller 271 informs the controller 126 of the tape library 120 of that fact and the controller 126 of the tape library 120 informs the controller 102 of the management apparatus 100. Therefore, the controller 102 can obtain information from the controller 126 of the tape library 120, on which magazine 250 in the tape library 120 has the battery 272 as the target battery. If necessary, the controller 102 sends a display command to the tape library 120 so as to display red on the display unit 276 of the target magazine 250. A display color and method are not limited, similar to the step 1292.

When the target battery is the battery 284 of the active tag 280 of the magazine 250 and the magazine 250 is loaded in the tape library 120, the tag reader 138 of the tape library 120 shown in the left bottom in FIG. 8 communicates with the active tag 280 and informs the controller 126 of the tape library 120 of that fact and the controller 126 of the tape library 120 then informs the controller 102 of the management apparatus 100. Thus, the controller 102 can acquire information from the controller 126 of the tape library 120, on which battery 284 of the active tag 280 of the magazine 250 is the target battery. If necessary, the controller 102 sends a display command to the active tag 280 via the radio communication unit 128, as described in the step 1292, so as to display red on the display unit 276 of the target magazine 250. In replacing the tag reader 138 with a reader/writer, the controller 102 may send a display command to the tape library 120, and the reader/writer may store the display command in the active tag 280, so as to display red on the display unit 276 in the target magazine 250 as described for the step 1292.

When the target battery is the battery 272 of the control unit 270 of the magazine 250 and the magazine 250 is arranged in the warehouse 15, the controller 271 writes the data in the memory 286 via the reader/writer 277 and the radio communication unit 288 of the active tag 280 informs the radio communication unit 128 of that fact and the radio communication unit 128 informs the controller 102 of the management apparatus 100. Therefore, the controller 102 can identify the magazine 250 having that battery.

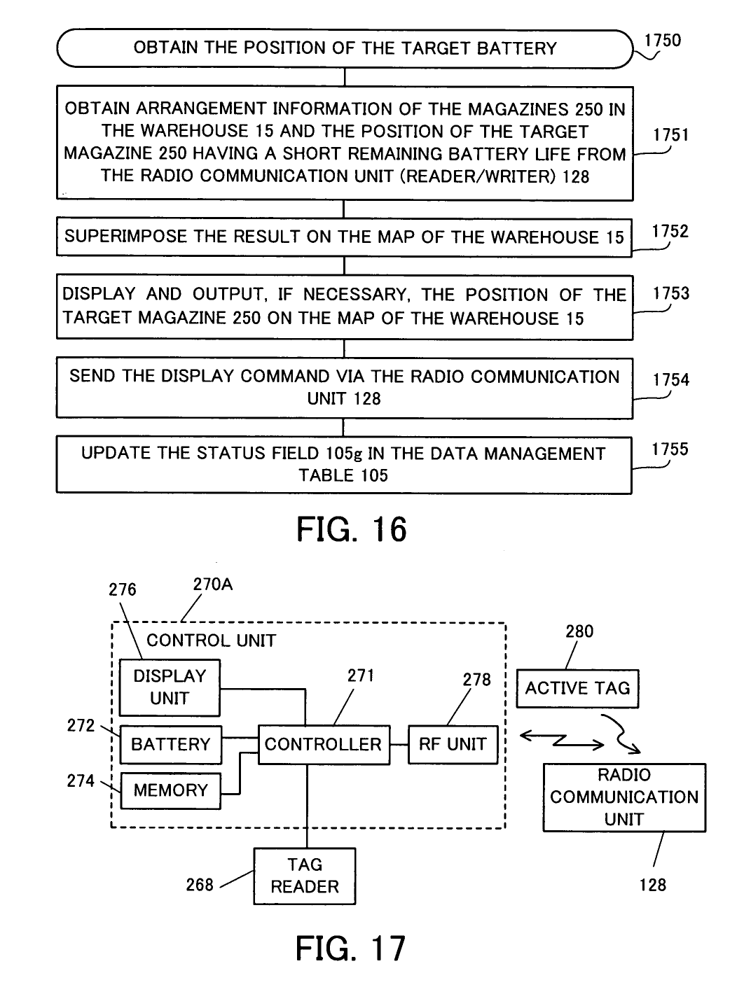

Referring to FIG. 16, a description will be given of the identifying method. Here, FIG. 16 is a flowchart for explaining a method for identifying the magazine 250 having a short remaining battery life in the warehouse 15. Initially, the controller 102 acquires the arrangement information of the magazines 250 in the warehouse 15 and information on the magazine 250 having a short remaining battery life through the communication unit 127 and the radio communication unit 128 of the tape library 120 (step 1751). The arrangement information is the same as the arrangement information acquired in the step 1272. Next, the controller 102 superimposes the results of the step 1751 on the map of the warehouse 15 (step 1752). Next, the controller 102 displays the position of the target magazine 250 on the map of the warehouse 15 on the display unit 108 or outputs it to the output unit 109, if necessary (step 1753). Next, the controller 102 sends a display command via the radio communication unit 128 (step 1754). The controller 271 displays red on the display unit 276 based on the display command. Thereby, an operator can easily find the target magazine 250 in the warehouse 15. Next, the controller 102 updates the status field 105g in the data management table 105 like the data 000007 in FIG. 2 (step 1278). When an exchange of the battery 272 is completed, the controller 102 updates and blanks out the status field 105g in the data management table 105.

When the target battery is the battery 284 of the active tag 280 of the magazine 250 and the magazine 250 is located in the warehouse 15, the radio communication unit 288 of the active tag 280 informs the radio communication unit 128 of that fact and the radio communication unit 128 then informs the controller 102 of the management apparatus 100. Therefore, the controller 102 identifies the magazine 250 having that active tag 280. The identifying method is similar to that shown in FIG. 16, and a description thereof will be omitted.

Next, the controller 102 determines whether an arrangement of the tape cartridges 200 in the magazine 250 has changed (step 1760) so as to, for example, check whether an authorized person picked up one of the tape cartridges 200 in the magazine 250. The controller 102 made the determination of the step 1760 by storing the just previous arrangement of the tape cartridges 200 in the magazine 250 and comparing the just previous arrangement with the current arrangement. When finding the abnormality the controller 102 informs an operator by displaying a warning message on the display unit 108 or by outputting an alarm sound from the output unit 109 (step 1770). When determining that there is no change in arrangement of the tape cartridges 200 in the magazine 250 (step 1760), the flow returns to the step 1710.

### Second Embodiment

FIG. 17 is a block diagram of the control system of a second embodiment corresponding to the control system shown in FIG. 12. The magazine 250 of this embodiment is different from that of the first embodiment in that the magazine 250 of this embodiment uses a control unit 270A instead of the control unit 270. The control unit 270A is different from the control unit 270 in that the control unit 270A includes a memory 274 and a radio communication unit 278 in addition to the controller 271, the battery 272, and the display unit 276 and the control unit 270A has no reader/writer 277.

According to this embodiment, the communication of the active tag 280 and the communication of the radio communication unit 278 are independent. The active tag 280 stores only the identifier of the magazine 250, and does not store any other data. In operation, the active tag 280 sends the stored identifier to the radio communication unit 128. The controller 271 reads the identifier of the tape cartridge 200 using the tag reader 268 and stores it in the memory 274, and reads the remaining life information of the battery 272 (exchange information or broadly speaking status information of the magazine 250) and stores it in the memory 274. The status information of the magazine 250 to be stored in the memory 274 includes positional information of the magazine 250. Next, the information stored in the memory 274 is sent from the radio communication unit 278 to the radio communication unit 128.

In this case, in the step 1272 shown in FIG. 14C, the controller acquires the arrangement information of the magazines 250 from the active tag 280, and acquires the arrangement information of the tape cartridges 200 from the radio communication unit 278. In the step 1277, the radio communication unit 278 receives the display command. The step 1290 shown in FIG. 14D is removed, and the step 1291 may be replaced with a phrase “the controller 271 stores in the memory 274 the display command acquired from the radio communication units 128 and 278.”

This embodiment can also provide an effect of locating the target magazine 250 and the target tape cartridge 200.

The radio communication unit 278 also serves as a (second) transmitter configured to transmit the identifier of the tape cartridge 200 and the identifier of the magazine 250 to the tape library 120. The transmission may be made on a regular basis, such as once a day, or when the previously transmitted information has changed. For example, an authorized person picked up the tape cartridge 200 from the magazine 250 in the warehouse 15. The controller 271 can determine whether the previously transmitted information has changed by storing in the memory 274 the just previous arrangement of the tape cartridges 200 in the magazine 250 and by comparing it with the current arrangement.

### Third Embodiment

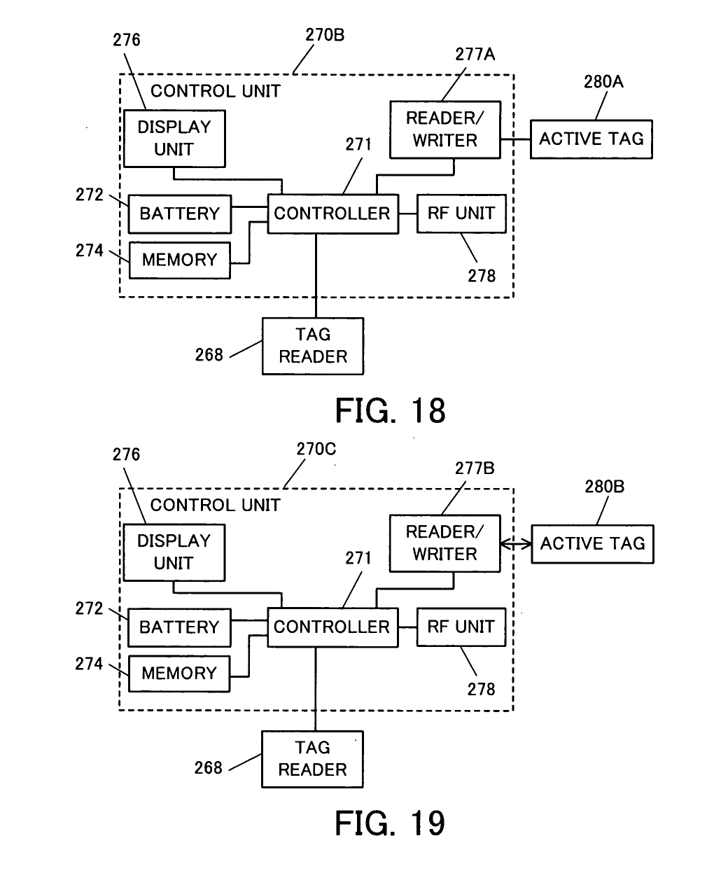

FIG. 18 is a block diagram of the control system of a third embodiment corresponding to the control system shown in FIG. 12. The magazine 250 of this embodiment is different from that of the first embodiment in that the magazine 250 of this embodiment uses a control unit 270B instead of the control unit 270 and a passive tag 280A instead of the active tag 280. The control unit 270B is different from the control unit 270 in that the control unit 270B includes the memory 274 and the radio communication unit 278 in addition to the controller 271, the battery 272, and the display 276, and further includes a tag reader 277A instead of the reader/writer 277. Nevertheless, the reader/writer 277 may be used instead of the tag reader 277A.

According to this embodiment, the magazine 250 uses the passive tag 280A that does not have a radio communicatable distance with the radio communication unit 128. In operation, the tag reader 277A reads the identifier stored in the passive tag 280A and stores it in the memory 274. The tag reader 268 reads the identifier of the tape cartridge 200, and stores it in the memory 274. Moreover, the controller 271 reads and stores in the memory 274 the remaining life information of the battery 272 (exchange information or broadly speaking the status information of the magazine 250). The status information of the magazine 250 to be stored in the memory 274 includes the positional information of the magazine 250. Next, the controller 271 sends the information stored in the memory 274, from the radio communication unit 278 to the radio communication unit 128.

In this case, the operation of this embodiment is similar to the operation shown in FIGS. 14C and 16 except the radio communication unit 128 communicates with the radio communication unit 278. In addition, the step 1290 is removed from FIG. 14D, and the step 1291 may be replaced by a phrase “the controller 271 stores in the memory 274 the display command acquired from the radio communication units 128 and 278.”

According to this embodiment, the magazine 250 has no expensive active tag 280, and the battery 272 serves as a battery of the active tag 280 and improves the maintainability because it is unnecessary to exchange two types of batteries.

Alternatively, the active tag 280 may be used, and the tag reader 277A may read the identifier of the magazine 250 stored in the active tag 280 and store it in the memory 274. In addition, the tag reader 268 may read the identifier of the tape cartridge 200 in the memory 274, and the radio communication unit 278 may send these identifiers.

### Fourth Embodiment

FIG. 19 is a block diagram of the control system according to a fourth embodiment corresponding to the control system shown in FIG. 12. The magazine 250 of this embodiment is different from that of the third embodiment in that the magazine 250 of this embodiment uses a control unit 270C instead of the control unit 270B and a barcode label 2803 instead of the passive tag 280A. The control unit 270C is similar to the control unit 2703 because the control unit 270C includes the controller 271, the battery 272, the memory 274, the display 276, and the radio communication unit 278. However, the control unit 270C is different from the control unit 270B in that the control unit 270C further includes a barcode reader 277B instead of the tag reader 277A.

According to this embodiment, the magazine 250 uses the barcode label 280B that does not have a communicatable distance with the radio communication unit 128. In operation, the barcode reader 277B reads and stores in the memory 274 the identifier represented by the barcode label 280B, and the tag reader 268 reads and stores in the memory 274 the identifier of the tape cartridge 200. Moreover, the controller 271 reads and stores in the memory 274 the remaining life information of the battery 272 (exchange information or broadly speaking the status information of the magazine 250). The status information of the magazine 250 to be stored in the memory 274 includes the positional information of the magazine 250. Next, the controller 271 sends the information stored in the memory 274, from the radio communication unit 278 to the radio communication unit 128.

In this case, the operation of this embodiment is similar to the operation shown in FIGS. 14C and 16 except that the radio communication unit 128 communicates with the radio communication unit 278. In addition, the step 1290 is removed from FIG. 14D, and the step 1291 may be replaced by a phrase “the controller 271 stores in the memory 274 the display command acquired via the radio communication units 128 and 278.”

According to this embodiment, the magazine 250 uses the barcode label 280B that is less expensive than the passive tag 280A, and does not require a battery, thereby saving power.

### Fifth Embodiment

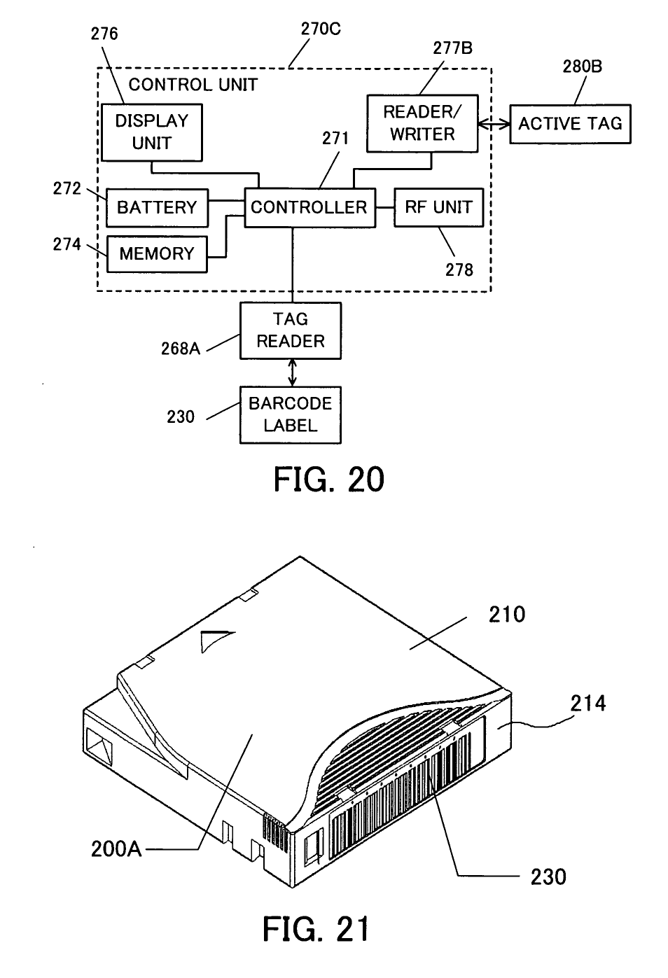

FIG. 20 is a block diagram of the control system according to a fifth embodiment corresponding to the control system shown in FIG. 12. The magazine 250 of this embodiment is similar to that of the fourth embodiment because both uses the control unit 270C but is different from that of the fourth embodiment in that the magazine 250 of this embodiment uses a barcode reader 268A instead of the tag reader 268 and a barcode label 230 instead of the passive tag 220.

FIG. 21 is a perspective view of a tape cartridge 200A mounted with the barcode label 230. According to the tape cartridge 200A, the barcode label 230 is adhered to a back surface 214 of the case 210 which is the same as that of the tape cartridge 200. The barcode label 230 represents an identifier of the tape cartridge 200A. Since the barcode label 230 is a mere printed matter that is less expensive than the passive tag, the cost is more effectively reduced.

When the tape cartridge 200A to which the barcode label 230 is attached is moved from the tape library 120 to the warehouse 15 as in the prior art, an operator cannot locate the tape cartridge 200A from the management room 11. Accordingly, this embodiment provides the barcode reader 268A and the radio communication unit 278 to the magazine 250 so that the tape cartridge 200 in the warehouse can be tracked down from the management room 11.

In operation, the barcode reader 268A reads and stores in the memory 274 the identifier represented by the barcode label 230. The barcode reader 277B reads and stores in the memory 274 the identifier represented by the barcode label 280B. Moreover, the controller 271 reads and stores in the memory 274 the remaining life information of the battery 272 (exchange information or broadly speaking the status information of the magazine 250). The status information of the magazine 250 to be stored in the memory 274 includes the positional information of the magazine 250. Next, the controller 271 sends the information stored in the memory 274, from the radio communication unit 278 to the radio communication unit 128. The changing points in the operation are similar to those of the fourth embodiment.

According to this embodiment, the tape cartridge 200A uses the barcode label 230 that is less expensive than the passive tag 220, thereby reducing the cost.

Of course, the fifth embodiment can be combined with any one of the first embodiment to the fourth embodiment.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

The present invention can provide a hierarchical storage system that can manage data well, a library apparatus, a magazine, and a control method of the hierarchical storage system.

What is claimed is:

1. A hierarchical storage system comprising:
a disc drive configured to primarily store data;
a library apparatus connected to the disc drive and configured to secondarily store the data; and
a control apparatus configured to control a transfer of the data between the disc drive and the library apparatus,
wherein the library apparatus includes:
a port into which a magazine configured to house a cartridge is inserted and from which the magazine is ejected, the cartridge including a first tag and being configured to store a storage medium configured to store the data, and the magazine including a second tag;
an information acquisition unit configured to acquire through a radio communication first information held by the first tag and configured to identify the cartridge and second information held by the second tag and configured to identify the magazine; and
a first transmitter configured to transmit to the control apparatus the first information and the second information that have been acquired, and
wherein the control apparatus includes a first memory configured to store the first information and the second information transmitted from the library apparatus; and
a management unit configured to manage a location of the data based on a data transfer status between the disc drive and the library apparatus and the first information and the second information stored in the first memory.

2. A hierarchical storage system according to claim 1, wherein the magazine includes:
a reader configured to read the first information; and
a second transmitter configured to transmit the first information and the second information to the library apparatus.

3. A hierarchical storage system according to claim 2, wherein the second tag is an active tag,
wherein the magazine further includes a writer configured to write the first information in the second tag, and
wherein the second transmitter is a part of the second tag.

4. A hierarchical storage system according to claim 3, wherein the second tag holds status information of the magazine.

5. A hierarchical storage system according to claim 2, wherein the second transmitter is configured to transmit the first information and the second information to the library apparatus on a regular basis.

6. A hierarchical storage system according to claim 2, wherein the second transmitter is configured to transmit the first information and the second information to the library apparatus when information previously transmitted by the second transmitter has changed.

7. A hierarchical storage system according to claim 2, wherein the magazine further includes a second memory configured to store the first information and the second information, and
wherein the second transmitter is configured to transmit to the library apparatus the first information and the second information that are stored in the second memory.

8. A control method of a hierarchical storage system that includes a disc drive configured to primarily store data, a library apparatus connected to the disc drive and configured to secondarily store the data, and a control apparatus configured to control a transfer of the data between the disc drive and the library apparatus, said control method comprising:
acquiring, from a magazine configured to house a cartridge through a radio communication via an information acquisition unit of the library apparatus, first information held by a first tag and configured to identify the cartridge and second information held by a second tag and configured to identify the magazine, the cartridge including the first tag and being configured to store a storage medium configured to store the data, the magazine including the second tag,
transmitting to the control apparatus via the library apparatus, the first information and the second information that have been acquired;
storing, via the control apparatus, the first information and the second information in a memory, which have been sent from the library apparatus; and
managing a location of the data via the control apparatus based on a data transfer status between the disc drive and the library apparatus and the first information and the second information stored in the memory.

9. A library apparatus configured to manage a storage medium configured to store data, said library apparatus comprising:
a port into which a magazine configured to house a cartridge is inserted and from which the magazine is ejected, the cartridge including a first tag and being configured to store the storage medium, and the magazine including a second tag;
an information acquisition unit configured to acquire through a radio communication first information held by the first tag and configured to identify the cartridge and second information held by the second tag and configured to identify the magazine; and
a management unit configured to manage a location of the data based on a data storing status into the storage medium and the first information and the second information.

10. A magazine configured to house a cartridge, the cartridge being configured to store a storage medium that is configured to store data, said magazine comprising:
a reader configured to read first information, the first information being configured to identify the cartridge and held by a first tag that is provided to the cartridge;
a second tag configured to hold second information configured to identify the magazine; and
a transmitter configured to transmit the first information.

11. A hierarchical storage system comprising:
a disc drive configured to primarily store data;
a library apparatus connected to the disc drive and configured to secondarily store the data, a magazine configured to house a cartridge being configured to be inserted into and ejected from the library apparatus, the cartridge including a first tag configured to hold first information and being configured to store a storage medium configured to store the data, and the magazine including a first radio communication unit and a second tag configured to hold second information, the first information being configured to identify the cartridge, and the second information being configured to identify the magazine;
a control apparatus configured to control a transfer of the data between the disc drive and the library apparatus; and
a second radio communication unit configured to communicate with the first radio communication unit,
wherein the control apparatus detects a position of the cartridge based on the first information and the second information which the second radio communication unit has received from the first radio communication unit.

12. A hierarchical storage system according to claim 11, wherein there are a plurality of magazines each configured to house a plurality of cartridges,
wherein the second radio communication unit acquires from the first radio communication unit arrangement information of the magazines in a warehouse configured to store the magazines, and
wherein the arrangement information contains positional information of each magazine, an identifier of each magazine, and an identifier of each cartridge housed in each magazine.

13. A hierarchical storage system according to claim 12, wherein the control apparatus further includes a memory configured to store a map of the warehouse, and
wherein the control apparatus is configured to identify positions of the cartridges in the warehouse by superimposing the arrangement information of the magazines on the map of the warehouse.

14. A hierarchical storage system according to claim 12, wherein the magazine further includes a display unit, and
wherein the control apparatus transmits a display command to be displayed on the display unit of the magazine, to the first radio communication unit via the second radio communication unit.

15. A hierarchical storage system according to claim 12, wherein the magazine further includes a battery,
wherein the first radio communication unit is configured to transmit information on a short remaining battery life of the magazine to the second radio communication unit, and
wherein the control apparatus further includes a memory configured to store a map of the warehouse, and is configured to identify a position of the magazine having the short remaining battery life in the warehouse by superimposing the arrangement information of the magazines on the map of the warehouse.

16. A hierarchical storage system according to claim 15, wherein the magazine further includes a display unit, and
wherein the control apparatus is configured to transmit a display command to be displayed on the display unit of the magazine, to the first radio communication unit via the second radio communication unit.
